(19) United States
(12) Patent Application Publication
(10) Pub. No.: US 2012/0000494 A1
(43) Pub. Date: Jan. 5, 2012

(54) WET BENCH APPARATUS AND METHOD

(75) Inventors: Jason PAULMAN, Corvallis, OR (US); Bruce Kenneth Smith, Corvallis, OR (US); Raymond Sohn, Corvallis, OR (US)

(73) Assignee: ATS AUTOMATION TOOLING SYSTEM INC., Cambridge (CA)

(21) Appl. No.: 13/077,499

(22) Filed: Mar. 31, 2011

Related U.S. Application Data
(60) Provisional application No. 61/319,824, filed on Mar. 31, 2010.

(51) Int. Cl. B08B 3/00

(52) U.S. Cl. 134/82

(57) ABSTRACT

A wet bench system comprising a plurality of sequentially aligned containers. A first rail positioned generally horizontally adjacent a first side of the container and a first arm having a first end moveable on the first rail. A second rail positioned generally horizontally and adjacent a second side of the container and having a second arm having a first end moveable on the second rail. The arms being capable of moving articles to be treated by chemicals in containers by movement in a back and forth leap frog fashion.

### RELATED APPLICATIONS

This application claims priority from U.S. Provisional Application No. 61/319,824 filed Mar. 31, 2010, which is hereby incorporated by reference.

### FIELD

This application relates to a wet bench apparatus and method for treating articles by immersion in various tanks containing liquids. In particular, this application relates to a wet bench for treating articles such as silicon wafers and gravel.

### BACKGROUND

A wet bench apparatus is used to treat articles typically placing the articles into a series or sequence of tanks containing different chemical compositions. In particular, the wet bench assembly may consist of multiple tanks. In a chemical etching procedure, an article may be dipped in the first tank containing an acidic chemical, and then moved to a subsequent tank containing water to rinse the acidic chemical, in may then be moved to an area for air drying and/or vacuum drying. To move the articles, an over-head crane or gantry is used which has hooks to pick up cassettes or mesh cages containing the articles being treated, for example wafers and/or silicon gravel. In particular, the wafers may be silicon wafers for, for example photovoltaic (PV) applications.

Known wet bench systems are typically only well suited for operation in a sequential fashion where articles advance along consecutive baths in order. For example, a single over-head crane can move cassettes or mesh cages containing the articles sequentially from a first tank to a second tank and then to a drying station. However, where spatial constraints are imposed and/or the articles have to be moved for example from the first bath to the second bath, and then back to the first bath, known wet bench systems are not advantageous.

Other methods in the past use either a return route external to the bench, or require the main gantry to be used for the return.

As such, there is need for an improved system and apparatus for and method of operating a wet bench.

### SUMMARY

This application is directed to a wet bench apparatus which can provide for continuous rack and pinion motion with multiple robots mounted on a single linear axis to work in a wet bench with overlapping work areas.

This application also provides for leap frog motion whereby the platform uses two linear motion rails along the length of the wet bench on opposite sides of the tanks from each other. This arrangement can allow robots to move past one another within the wet bench and can reduce cycle time and can also prevent a potentially acid-contaminated part from being removed from the safety of a fume and drip containment of the wet bench for return to the beginning.

In one aspect, a wet bench apparatus is provided, comprising: a first arm movable in a horizontal direction of a container; and a second arm movable in the horizontal direction.

In a preferred case, the first and second arms are positioned on a same side of the container.

In a preferred case, the first arm and the second arm are positioned on opposite sides of the container.

In a preferred case, the first arm and second arms are movable in a vertical direction.

In a preferred case, the first arm is adapted to move at least one first item, and the second arm is adapted to move at least one second item, the first item and the second item being movable into and out of a plurality of treatment containers and the first arm and the at least one first item are positionable in a user specified orientation to move without contacting the second arm and the at least one second item.

In a preferred case, the first arm is connected to a first robot and the second arm is connected to a second robot, the first robot being movable on a first track, the second robot being movable on a second track.

In a preferred case, the first robot has a first cam follower system comprising at least one cam roller positioned between a first guide bar and a second guide bar, and the second robot has a second cam follower system comprising at least one cam roller positioned between a first guide bar and a second guide bar.

In a preferred case, the first robot has a first cam follower system comprising a first cam roller positioned on one side of a guide bar and a second cam roller positioned on an opposite side of the guide bar, and the second robot has a second cam follower system comprising a first cam roller positioned on one side of a guide bar and a second cam roller positioned on an opposite side of the guide bar.

In a preferred case, the first and second robots, the first and second arms, and the first and second tracks are made of corrosion resistant material.

In another aspect, a wet bench system is provided, comprising: a first container; a first rail positioned generally horizontally adjacent a first side of the container, a first arm having a first robot moveable on the first rail; and a second rail positioned generally horizontally adjacent a second side of the container, a second arm having a second robot moveable on the second rail.

In a preferred case, the first and second arms are also movable in a vertical direction.

In a preferred case, the first arm has a first end effector connected to a second end of the first arm opposite to the first end, and the second arm has a second end effector connected to a second end of the second arm opposite to the first end.

In a preferred case, a second container is positioned proximate to the first container in the horizontal direction and wherein the first arm is operable to move at least one first item and the second arm is operable to move at least one second item from the first container to the second container, the first arm and the at least one first item are positionable in a user specified orientation to move without contacting the second arm and at least one second item.

In a preferred case, the first robot has a first cam follower system comprising at least one cam roller positioned between a first guide bar and a second guide bar, and the second robot has a second cam follower system comprising at least one cam roller positioned between a first guide bar and a second guide bars.

In a preferred case, the first robot has a first cam follower system comprising a first cam roller positioned on one side of a guide bar and a second cam roller positioned on an opposite side of the guide bar, and the second robot has a second cam follower system comprising a first cam roller positioned on one side of a guide bar and a second cam roller positioned on an opposite side of the guide bar.

In a preferred case, the first and second robots, the first and second arms, and the first and second tracks are made of corrosion resistant material.

Other aspects and features will become apparent to those ordinarily skilled in the art upon review of the following description of specific embodiments in conjunction with the accompanying figures.

### BRIEF DESCRIPTION OF FIGURES

For a better understanding of the embodiments described herein and to show more clearly how they may be carried into effect, reference will now be made, by way of example only, to the accompanying drawings which show the exemplary embodiments and in which:

FIG. 1 shows an end view of a “leap frog” robot arm system with one arm shown raised to clear second arm;

FIG. 2 shows a cam follower system having a double guide bar arrangement;

FIG. 3 shows a cam follower system having a single guide bar arrangement;

FIG. 4 shows a system with multiple robots on the same linear axis; and

FIG. 5 shows multiple cable tracks for other robots.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

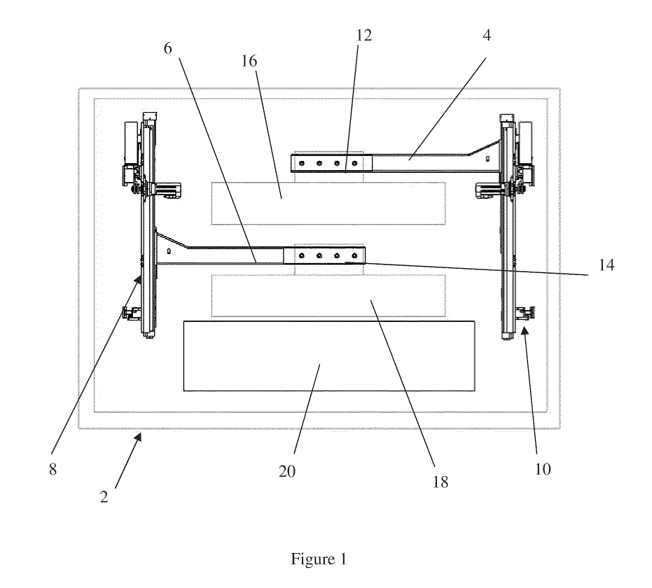

FIG. 1 shows an end view of a “leap frog” robot arm system 2 with a first arm 4 vertically raised to clear second arm 6. As shown, the system 2 uses a first robot 8 positioned on one side of the process tank, and a second robot 10 positioned on an opposite side of the process tank, to move respective arms 4 and 6. As shown, the first arm 4 has a first end effector 12 positioned thereon. The second arm 6 has a second end effector 14 positioned thereon.

The first end effector 12 is shown lifting a first product 16. The second end effector is shown lifting a second product 18. Preferably, the first product 16 and the second product 18 are silicon wafers or gravel. As shown, the first arm 4 and product 16 are lifted vertically so as to clear the second arm 6, when the respective first and second arms 4, 6 are moved in a horizontal direction in or out of the page.

Also shown in FIG. 1 is a process tank 20 which can contain chemicals into which the first product 16 and/or second product 18 can be placed for processing the product.

Each of the first and second robots, 8 and 10, preferably has two servo-controlled axis: (a) a Z-axis that is long enough to place the product in the process tanks and to pass over the second robot while carrying product; and (b) an X-axis that runs a length of the wet bench system.

The first and second robot arms, 4 and 6, can be made of coated stainless steel, such as Teflon™ coated stainless steel. The linear motion rails and the rack and pinion system can be coated with a black chrome coating impregnated with Teflon™, such as Raydent™. These components may then be coated with a Teflon™ based grease such as DuPont Krytox™ to increase corrosion protection. Preferably, the motors on the robots are chemical duty motors with air purge.

The system 2 having the first robot arm 4 and second robot arm 6 which can be vertically off-set from each other is advantageous in enabling moving items from bath tank to bath tank without requiring handing off from one robot arm to another. Further, the vertically off-set robot arms, 4 and 6, advantageously increase throughput of the process and avoid time consuming steps such as handing off or the need for a staging area to set one cage down and pick another up.

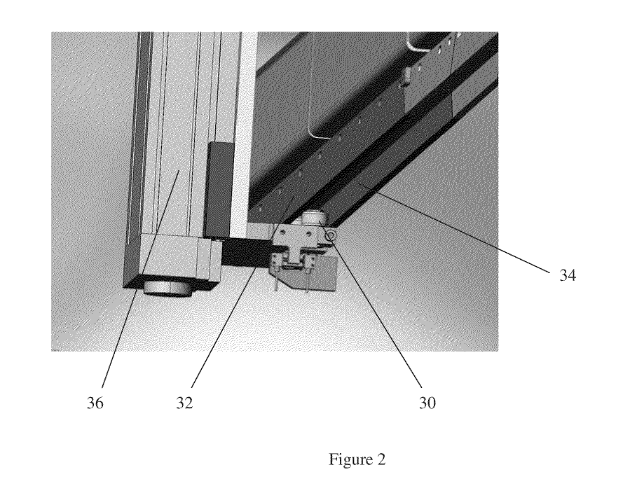

FIG. 2 shows a cam follower system having a single rack as the motion backbone for multiple robots. The cam follower system of FIG. 2 has a double guide bar arrangement whereby a set of cam rollers 30 run between a first guide bar 32 and a second guide bar 34. Preferably, the guide bar arrangement is made of corrosion resistant or coated material. An upper rail (not shown) supports the robot, and the cam rollers 30 are provided to resist moment. Preferably, at least three rollers are provided in the set of cam rollers 30. The double guide bar arrangement protects the rollers 30 from drips.

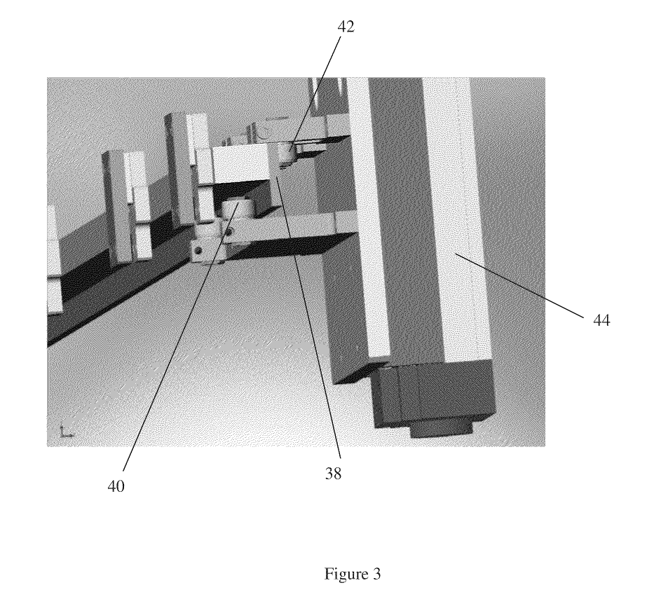

FIG. 3 shows a cam follower system having a single bar arrangement. As shown, a single bar 38 is provided with a first roller set 40 on one side of the bar 38, and a second roller set 42 on an opposite side of the bar 38. A robot 44 is attached to an upper rail (not shown) and the first roller set 40 and the second roller set 42 are provided to resist moment. Preferably, the linear guide system for the lower portion of the linear axis is low-cost and easily replaceable.

To resist corrosion, the components of the cam follower system shown in FIGS. 2 and 3 can be coated with a corrosion resistant coating. For example, the corrosion resistant coating may be Raydent™, Armalloy™, or NiCoTef™. Preferably, the robots 36 and 44 carry their own pinion and drive motor. Each robot 36 and 44 can pull a cable chain to supply it with compressed air, communications, and electricity, as desired.

In the arrangements shown in FIGS. 2 and 3, a moment from the long arm of the robot is resisted by the cam follower system. Preferably, the cam follower systems are a simple linear track mounted near the base of the wall. As these parts are generally positioned closer to a treatment bath tank, they may be deteriorated by fumes from the bath, and therefore are preferably made inexpensive and easy to replace.

Also, the segmented rack and rail design allows for very long travel. The system shown can have a rail length of approximately 22,000 mm, or just over 72 feet.

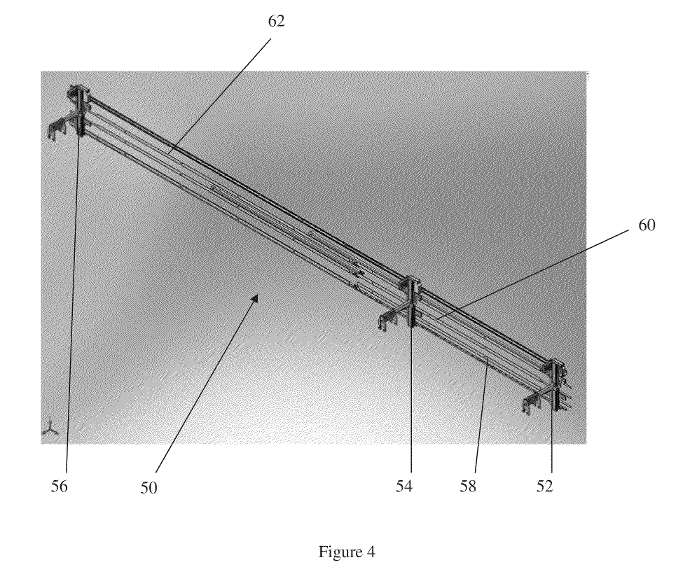

FIG. 4 shows a system 50 with multiple robots on the same linear axis. The robot system 50 has a first robot 52, a second robot 54, and a third robot 56. A respective cable track 58, 60, and 62 is run for each of the respective first robot 52, second robot 54, and third robot 56 in the system 50.

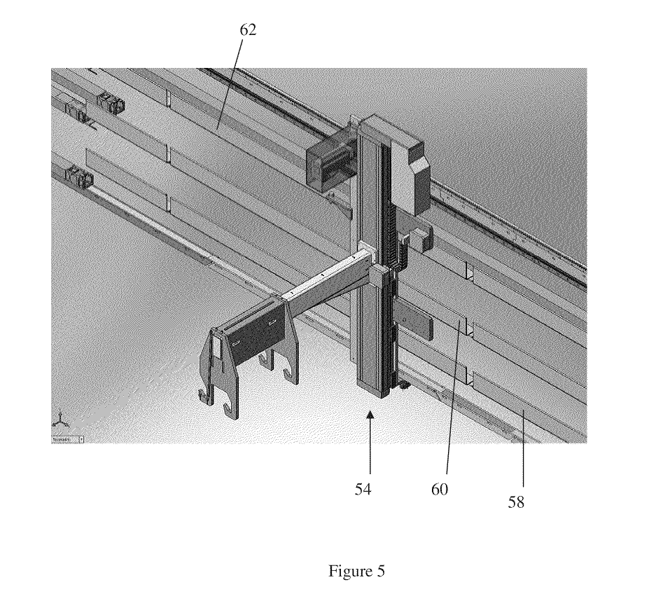

FIG. 5 shows the middle robot 54 of FIG. 4, as well as multiple cable tracks for other robots.

Although this disclosure has described and illustrated certain embodiments, it is also to be understood that the system, apparatus and method described is not restricted to these particular embodiments. Rather, it is understood that all embodiments which are functional or mechanical equivalents of the specific embodiments and features that have been described and illustrated herein are included.

It will be understood that, although various features have been described with respect to one or another of the embodiments, the various features and embodiments may be combined or used in conjunction with other features and embodiments as described and illustrated herein.

What is claimed is:

1. A wet bench apparatus, comprising:
a first arm movable in a horizontal direction of a container; and
a second arm movable in the horizontal direction.

2. The wet bench apparatus of claim 1, wherein the first and second arms are positioned on a same side of the container.

3. The wet bench apparatus of claim 1, wherein the first arm and the second arm are positioned on opposite sides of the container.

4. The wet bench apparatus of claim 3, wherein the first arm and second arms are movable in a vertical direction.

5. The wet bench apparatus of claim 4, wherein the first arm is adapted to move at least one first item, and the second arm is adapted to move at least one second item, the first item and the second item being movable into and out of a plurality of treatment containers and the first arm and the at least one first item are positionable in a user specified orientation to move without contacting the second arm and the at least one second item.

6. The wet bench apparatus of claim 5, wherein the first arm is connected to a first robot and the second arm is connected to a second robot, the first robot being movable on a first track, the second robot being movable on a second track.

7. The wet bench apparatus of claim 6, wherein the first robot has a first cam follower system comprising at least one cam roller positioned between a first guide bar and a second guide bar, and the second robot has a second cam follower system comprising at least one cam roller positioned between a first guide bar and a second guide bar.

8. The wet bench apparatus of claim 6, wherein the first robot has a first cam follower system comprising a first cam roller positioned on one side of a guide bar and a second cam roller positioned on an opposite side of the guide bar, and the second robot has a second cam follower system comprising a first cam roller positioned on one side of a guide bar and a second cam roller positioned on an opposite side of the guide bar.

9. The wet bench apparatus of claim 6, wherein the first and second robots, the first and second arms, and the first and second tracks are made of corrosion resistant material.

10. A wet bench system, comprising:
a first container;
a first rail positioned generally horizontally adjacent a first side of the container, a first arm having a first robot moveable on the first rail; and
a second rail positioned generally horizontally adjacent a second side of the container, a second arm having a second robot moveable on the second rail.

11. The wet bench system of claim 10, wherein the first and second arms are also movable in a vertical direction.

12. The wet bench system of claim 11, wherein the first arm has a first end effector connected to a second end of the first arm opposite to the first end, and the second arm has a second end effector connected to a second end of the second arm opposite to the first end.

13. The wet bench system of claim 12, comprising a second container positioned proximate to the first container in the horizontal direction and wherein the first arm is operable to move at least one first item and the second arm is operable to move at least one second item from the first container to the second container, the first arm and the at least one first item are positionable in a user specified orientation to move without contacting the second arm and at least one second item.

14. The wet bench apparatus of claim 10, wherein the first robot has a first cam follower system comprising at least one cam roller positioned between a first guide bar and a second guide bar, and the second robot has a second cam follower system comprising at least one cam roller positioned between a first guide bar and a second guide bars.

15. The wet bench apparatus of claim 10, wherein the first robot has a first cam follower system comprising a first cam roller positioned on one side of a guide bar and a second cam roller positioned on an opposite side of the guide bar, and the second robot has a second cam follower system comprising a first cam roller positioned on one side of a guide bar and a second cam roller positioned on an opposite side of the guide bar.

16. The wet bench apparatus of claim 10, wherein the first and second robots, the first and second arms, and the first and second tracks are made of corrosion resistant material.
